(19) United States
(12) Patent Application Publication
(10) Pub. No.: US 2025/0288831 A1
(43) Pub. Date: Sep. 18, 2025

(54) DESCENDED RESCUE DEVICE FOR BUILDING

(71) Applicants: Te-Hsin Lee, Taichung City (TW); Yun-Ru Lee, Taichung City (TW); En-Yu Lee, Taichung City (TW)

(72) Inventors: Te-Hsin Lee, Taichung City (TW); Yun-Ru Lee, Taichung City (TW); En-Yu Lee, Taichung City (TW)

(21) Appl. No.: 18/605,846

(22) Filed: Mar. 15, 2024

(30) Foreign Application Priority Data
Oct. 3, 2023 (TW) 112137938

(51) Int. Cl. A62B 1/20

(52) U.S. Cl. CPC A62B 1/20

(57) ABSTRACT

A descended rescue device for a building contains: a movable rod and a threaded structure. Descending thread rod includes external threads and a flange nut stop pin, and Open-closing flange nut structure for descending includes internal threads, a upper cover, a Load flange nut rotor, a bottom cap, a fixed connection element, and a movable connection element. The upper cover includes a first passing orifice, a Cutting face of upper cover, two second coupling orifices, a third coupling orifice, a fourth coupling orifice, multiple first rings, multiple second receiving orifices, Multiple outer ring thrust rollers, and Multiple inner ring thrust rollers. The bottom cap includes a second passing orifice, a third tangent slot, two third coupling orifices, a fourth coupling orifice, a fifth coupling orifice, multiple second rings, multiple third receiving orifices, multiple third threaded nuts, and multiple fourth threaded nuts. The fixed connection element includes a first lid, a second lid, a third lid, and two joining stems.

### TECHNICAL FIELD

The present disclosure relates to a descended rescue device which is simplified and operated stably and easily, and has high service life and low maintenance cost.

### BACKGROUND

Since the elevators used in general high-rise buildings are prone to stop operating due to power interruptions when a fire occurs, and the escape ladders are often blocked by the fire, many high-rise buildings are often equipped with additional slow-descent escape devices to prevent the building's escape ladders from being blocked. Backup escape device during fire interruption.

Existing slow-descent escape devices usually use rope suspension to hang evacuees from the outside of the building to the ground. However, this existing slow-descent device is easy to shake when used and lacks protection for personnel. Therefore, the escapers hang down. It is easy to be injured during the descent process, and users with weak physical strength in the fire scene cannot use it smoothly.

Therefore, fixed slow-down escape ladders later appeared on the market. However, the structures of existing fixed slow-down escape ladders are usually too complex, and the mechanisms are prone to failure, so they cannot be widely used and have poor reliability.

The present invention has arisen to mitigate and/or obviate the afore-described disadvantages.

### SUMMARY

A primary aspect of the present invention is to provide a descended rescue device which is simplified and operated stably and easily, and has high service life and low maintenance cost.

To obtain above-mentioned aspect, a descended rescue device provided by the present invention contains: a movable rod, a threaded structure.

Descending thread rod includes external threads formed on an outer wall thereof, and Open-closing flange nut structure for descending includes internal threads formed on a center thereof, descending thread rod further includes a flange nut stop pin, Open-closing flange nut structure for descending includes a upper cover, a Load flange nut rotor, a bottom cap, a fixed connection element, and a movable connection element. The Load flange nut rotor is defined between the upper cover and the bottom cap, and the Load flange nut rotor includes the internal threads formed on the center thereof to mate with the external threads of descending thread rod, a loading disc fixed on a top thereof, a coupling disc mounted on a bottom of the Load flange nut rotor, and two arcuate clamps disposed on the coupling disc. The loading disc has an Outer ring guide trench and an Inner ring guide trench formed on a top thereof, and the loading disc has a middle ring guide trench formed on a bottom thereof. The Load flange nut rotor includes a first tangent slot formed beside the center thereof, and the coupling disc has two first coupling orifices and two first receiving orifices located besides the first tangent slot.

The upper cover includes a first passing orifice defined on a center thereof, and the bottom cap includes a second passing orifice defined on a center thereof. The upper cover includes a Cutting face of upper cover formed beside the center of the upper cover, two second coupling orifices defined besides the Cutting face of upper cover, a third coupling orifice and a fourth coupling orifice which are located beside the Cutting face of upper cover opposite to the two second coupling orifices, multiple first rings extending from an outer peripheral side of the upper cover, and multiple second receiving orifices configured to receive multiple columns. The upper cover further includes Multiple outer ring thrust rollers and Multiple inner ring thrust rollers screwed on a bottom of the upper cover.

The bottom cap includes a second passing orifice defined on a center thereof, a third tangent slot formed beside the center of the bottom cap, two third coupling orifices defined besides the third tangent slot, a fourth coupling orifice and a fifth coupling orifice which are located beside the third tangent slot opposite to the two third coupling orifices, multiple second rings extending from an outer peripheral side of the bottom cap, and multiple third receiving orifices configured to receive multiple columns. The bottom cap further includes multiple third threaded nuts and multiple fourth threaded nuts screwed on a top of the bottom cap.

The fixed connection element includes a first lid, a second lid, a third lid, and two joining stems, and the first lid has a first hole, the second lid has a second hole, and the third lid has a third hole. The first lid is disposed on the top of the first cap, the second lid is mounted on the bottom of the bottom cap, and the third lid is defined between the upper cover and the bottom cap, a respective one joining stem is inserted through the first hole, a respective one second coupling orifice, the third hole and a respective one third coupling orifice to connect with the second hole.

The movable connection element includes a first cover, a second cover, a third cover, a locating shaft, and a second safety bolt. The second safety bolt has at least one second steel ball received on a bottom thereof, and the first cover has a first tab, a first opening, and a first aperture. The second cover has a second tab, a second opening, and a second aperture. The third cover has a third opening and a third aperture, the first cover is disposed on the top of the first cap, the second cover is fixed on the bottom of the bottom cap, and the third cover is defined between the first cap and the bottom cap.

Open-closing flange nut structure for descending is screwed with descending thread rod at any desired height so as to slide downward to descend along descending thread rod, and rescue equipment is hung by way of the upper cover, the bottom cap, the multiple first rings and the multiple second rings. The rescue equipment is escape suit.

Preferably, an end of the movable connection element is fixed by inserting the locating shaft through the first opening, the third coupling orifice of the upper cover, the third opening, the fourth coupling orifice of the bottom cap, and the second opening; the other end of the movable connection element is fixed by inserting the second safety bolt through the first aperture, the fourth coupling orifice, the third aperture, the fifth coupling orifice, and the second aperture, hence the at least one second steel ball of the second safety bolt moves across the second aperture to engage the movable connection element; after disengaging the at least one second steel ball from the second aperture, the second safety bolt is removed from the first aperture via the second aperture, the fifth coupling orifice, the third aperture, the fourth coupling orifice, and the first aperture; the first tab is welded on a peripheral side of a top of the third cover, and the second tab is welded on a peripheral side of a bottom of the third cover, hence the first cover, the second cover and the third cover are opened or closed together.

Preferably, the flange nut stop pin is configured to stop Open-closing flange nut structure for descending to descend.

Preferably, the coupling disc includes a respective one first coupling orifice and a respective one first receiving orifice, a respective one arcuate clamp is engaged with the Load flange nut rotor, and the first safety bolt is received in the second through orifice to open or close the Load flange nut rotor.

Preferably, when the descended rescue device descends, the Load flange nut rotor rotates so that the Multiple outer ring thrust rollers and the Multiple inner ring thrust rollers of the bottom cap and the third threaded nuts of the bottom cap roll in the outer groove, the Inner ring guide trench and the middle ring guide trench, but the upper cover and the bottom cap are not actuated to revolve, thus hanging the escape personnel by using the descended rescue device.

Preferably, a pulley is arranged on an exit of a building, and a fireproof rope is connected with the pulley, such that after using Open-closing flange nut structure for descending and rescue equipment, the rescue equipment is manually delivered to other floors of the building via the pulley and the fireproof rope.

Preferably, two movable rods are connected to form a combined movable rod so as to be applicable for different floors of the building, wherein the respective one movable rod includes two concentric holes defined on two ends thereof so as to connect with a splicing column, thus connecting the two movable rods; wherein the respective one movable rod further includes two Positioning hole defined on the two ends thereof and corresponding to the external threads, and a Positioning post is configured to align with and position the two movable rod so that the Load flange nut rotor moves on the two movable rods smoothly.

Preferably, the top and the bottom of descending thread rod are fixed by using an upper holder and a support base, and multiple U-shaped elasticity retainers are configured to stabilize descending thread rod, wherein any two adjacent U-shaped elasticity retainers are spaced at a predetermined distance; in a normal state, the multiple U-shaped elasticity retainers clamp descending thread rod; when an escape personnel slides downward, the multiple U-shaped elasticity retainers bent downward to remove from descending thread rod; after the escape personnel passes across the multiple U-shaped elasticity retainers, the multiple U-shaped elasticity retainers move back to original positions to maintain descending thread rod stably; in the normal state, the multiple U-shaped elasticity retainers are perpendicular to descending thread rod in multiple directions.

Other objects and features will be in part apparent and in part pointed out hereinafter.

### BRIEF DESCRIPTION OF THE DRAWINGS

FIG. 1 is a perspective view showing the exploded components of a descended rescue device according to a preferred embodiment of the present invention.

FIG. 2 is a cross sectional view showing the assembly of the descended rescue device according to the preferred embodiment of the present invention.

FIG. 3 is a cross sectional view showing the assembly of a part of the descended rescue device according to the preferred embodiment of the present invention.

FIG. 4 is a side plan view showing the operation of the descended rescue device according to the preferred embodiment of the present invention.

FIG. 5 is another side plan view showing the operation of the descended rescue device according to the preferred embodiment of the present invention.

FIG. 6 is also another side plan view showing the operation of the descended rescue device according to the preferred embodiment of the present invention.

FIG. 7 is still another side plan view showing the operation of the descended rescue device according to the preferred embodiment of the present invention.

FIG. 8 is a side plan view showing the application of the descended rescue device according to the preferred embodiment of the present invention.

FIG. 9 is a perspective view showing the application of the descended rescue device according to the preferred embodiment of the present invention.

### DETAILED DESCRIPTION

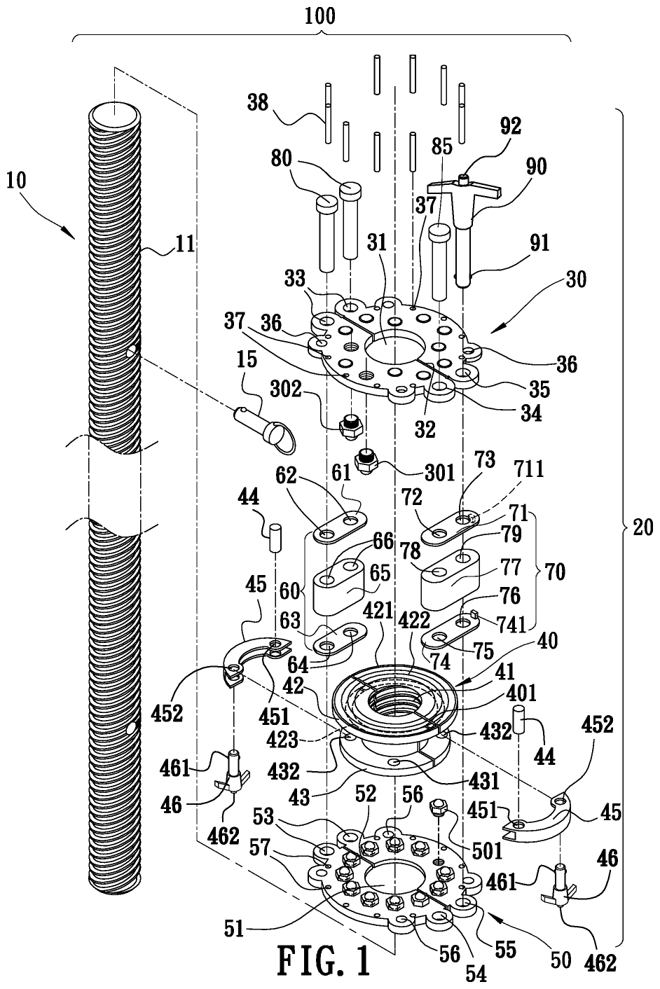

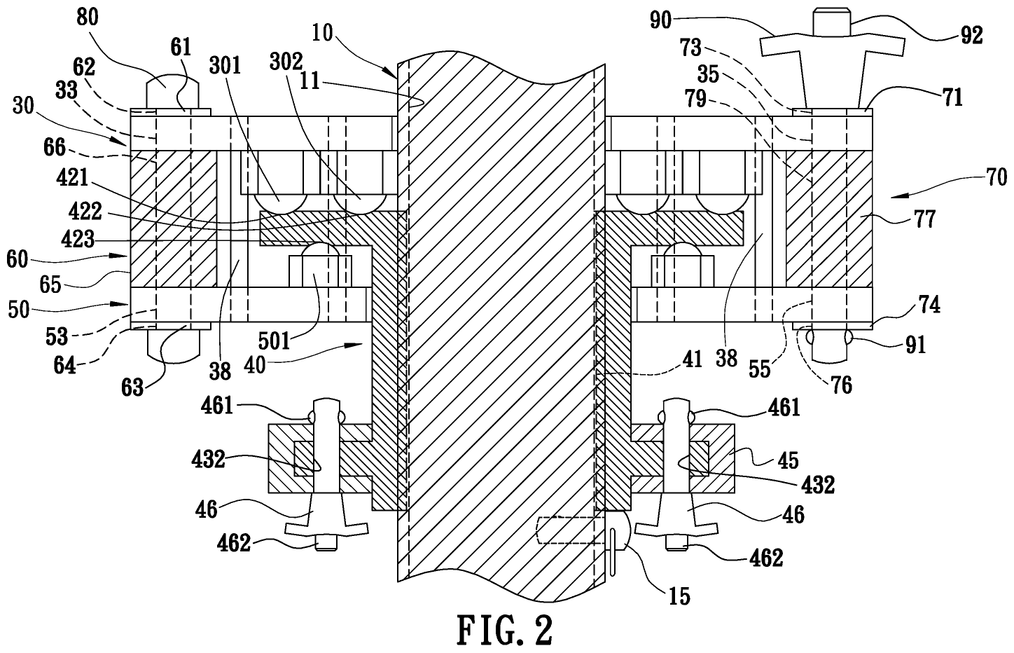

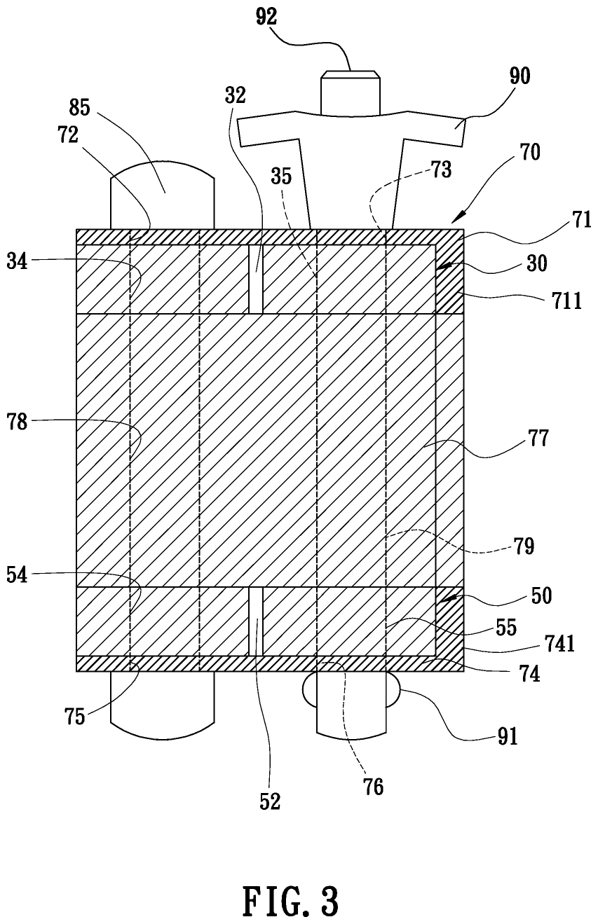

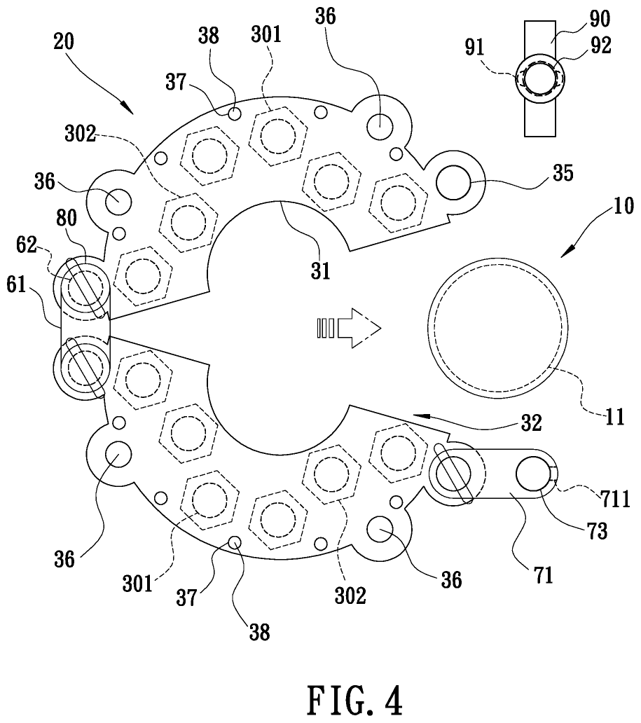

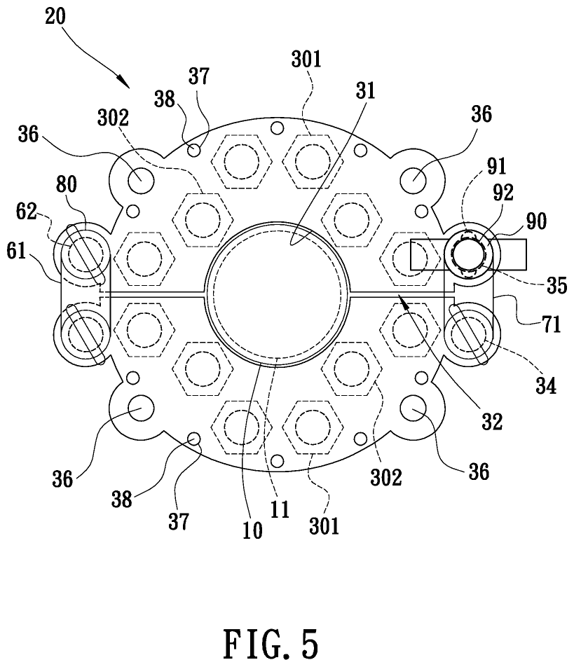

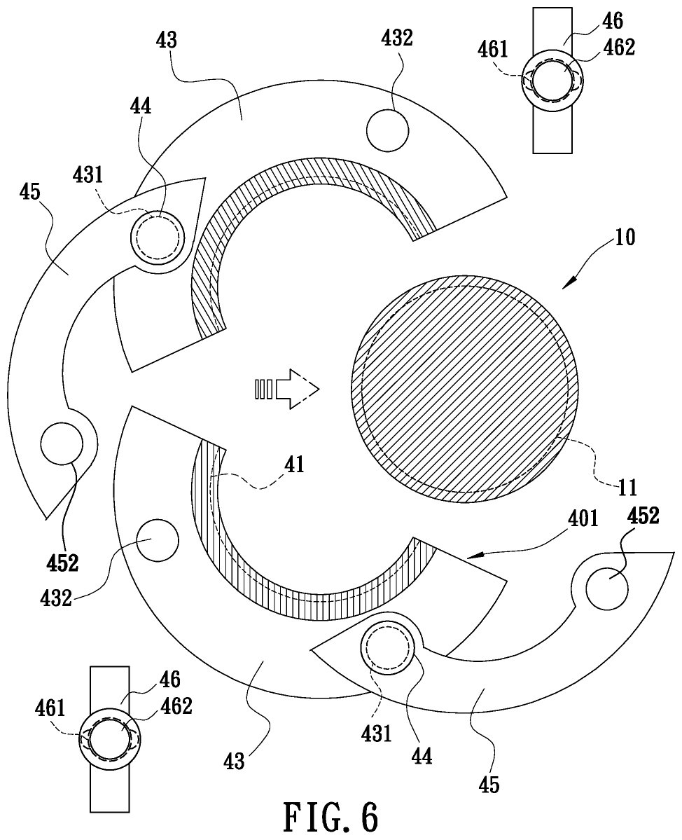

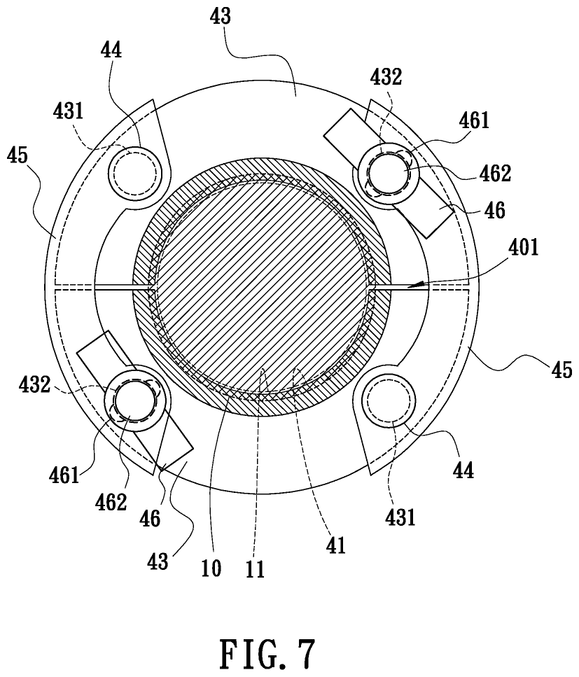

With reference to FIGS. 1-9, a descended rescue device 100 for a building according to a preferred embodiment of the present invention comprises: a movable rod 10 and a threaded structure 20. Descending thread rod 10 includes external threads 11 formed on an outer wall thereof, and Open-closing flange nut structure for descending 20 includes internal threads 41 formed on a center thereof and passing through the external threads 11 of descending thread rod 10 to rotatably descend. Descending thread rod 10 further includes a flange nut stop pin 15. Open-closing flange nut structure for descending 20 includes a upper cover 30, a Load flange nut rotor 40, a bottom cap 50, a fixed connection element 60, and a movable connection element 70, wherein the Load flange nut rotor 40 is defined between the upper cover 30 and the bottom cap 50, and the Load flange nut rotor 40 includes the internal threads 41 formed on the center thereof to mate with the external threads 11 of descending thread rod 10, a loading disc 42 fixed on a top thereof, a coupling disc 43 mounted on a bottom of the Load flange nut rotor 40, and two arcuate clamps 45 disposed on the coupling disc 43, wherein the loading disc 42 has an Outer ring guide trench 421 and an Inner ring guide trench 422 formed on a top thereof, and the loading disc 42 has a middle ring guide trench 423 formed on a bottom thereof, wherein the Load flange nut rotor 40 includes a first tangent slot 401 formed beside the center thereof. The coupling disc 43 has two first coupling orifices 431 and two first receiving orifices 432 located besides the first tangent slot 401, wherein the two first coupling orifices 431 are configured to receive two shafts 44, and the two first receiving orifices 432 are configured to receive two first safety bolts 46 so that the arcuate clamp 45 is opened and closed. A respective one arcuate clamp 45 has a first through orifice 451 and a second through orifice 452, wherein a respective one shaft 44 is inserted through the first through orifice 451 and a respective one first coupling orifice 431 so that the respective one arcuate clamp 45 rotates along the respective one shaft 44. The first safety bolt 46 has at least one first steel ball 461 mounted on a bottom thereof, a control knob 462 disposed on a top of the first safety bolt 46, wherein the first safety bolt 46 is inserted through the second through orifice 452 and a respective one first receiving orifice 432 from the coupling disc 63 to locate the at least one first steel ball 461 on the respective arcuate clamp 45. After removing the first safety bolt 46, the respective one clamp 45 expands outward to an angle of the first tangent slot 401 of the Load flange nut rotor 40, hence the respective one arcuate clamp 45 is engaged on descending thread rod 10. After engaging the Load flange nut rotor 40 on descending thread rod 10, the first tangent slot 401 and the respective one clamp 45 are closed, and the first safety bolt 46 is returned back to an original position so that Open-closing flange nut structure for descending 20 is screwed with the external threads 11 of descending thread rod 10.

The upper cover 30 includes a first passing orifice 31 defined on a center thereof, a Cutting face of upper cover 32 formed beside the center of the upper cover 30, two second coupling orifices 33 defined besides the Cutting face of upper cover 32, a third coupling orifice 34 and a fourth coupling orifice 35 which are located beside the Cutting face of upper cover 32 opposite to the two second coupling orifices 33, multiple first rings 36 extending from an outer peripheral side of the upper cover 30, and multiple second receiving orifices 37 configured to receive multiple columns 38, such that the upper cover 30 is connected with the bottom cap 50. Also, the upper cover 30 further includes Multiple outer ring thrust rollers 301 and Multiple inner ring thrust rollers 302 screwed on a bottom of the upper cover 30.

The bottom cap 50 includes a second passing orifice 51 defined on a center thereof, a third tangent slot 52 formed beside the center of the bottom cap 50, two third coupling orifices 53 defined besides the third tangent slot 52, a fourth coupling orifice 54 and a fifth coupling orifice 55 which are located beside the third tangent slot 52 opposite to the two third coupling orifices 53, multiple second rings 56 extending from an outer peripheral side of the bottom cap 50, and multiple third receiving orifices 57 configured to receive multiple columns 38, such that the bottom cap 50 is connected with the upper cover 30. Also, the bottom cap 50 further includes multiple third threaded nuts 501 and multiple fourth threaded nuts 502 screwed on a top of the bottom cap 50.

The fixed connection element 60 includes a first lid 61, a second lid 63, a third lid 65, and two joining stems 80, wherein the first lid 61 has a first hole 62, the second lid 63 has a second hole 64, and the third lid 65 has a third hole 66, wherein the first lid 61 is disposed on the top of the first cap 30, the second lid 63 is mounted on the bottom of the bottom cap 50, and the third lid 65 is defined between the upper cover 30 and the bottom cap 50, a respective one joining stem 80 is inserted through the first hole 62, a respective one second coupling orifice 33, the third hole 66 and a respective one third coupling orifice 53 to connect with the second hole 64. The loading disc 42 is defined between the first cap 30 and the second cap 50 by using the Multiple outer ring thrust rollers 301, the Multiple inner ring thrust rollers 302 and the third threaded nuts 501. The Multiple outer ring thrust rollers 301 contact with the Outer ring guide trench 421, the Multiple inner ring thrust rollers 302 abut against the Inner ring guide trench 422, and the multiple third threaded nuts 501 contact with the middle ring guide trench 423, thus defining the loading disc 42 securely.

The movable connection element 70 includes a first cover 71, a second cover 74, a third cover 77, a locating shaft 85, and a second safety bolt 90. The second safety bolt 90 has at least one second steel ball 91 received on a bottom thereof, and the first cover 71 has a first tab 711, a first opening 72, and a first aperture 73. The second cover 74 has a second tab 741, a second opening 75, and a second aperture 76. The third cover 77 has a third opening 78 and a third aperture 79. The first cover 71 is disposed on the top of the first cap 30, the second cover 74 is fixed on the bottom of the bottom cap 50, and the third cover 77 is defined between the first cap 30 and the bottom cap 50.

Referring to FIGS. 1-7, an end of the movable connection element 70 is fixed by inserting the locating shaft 85 through the first opening 72, the third coupling orifice 34 of the upper cover 30, the third opening 78, the fourth coupling orifice 54 of the bottom cap 50, and the second opening 75. The other end of the movable connection element 70 is fixed by inserting the second safety bolt 90 through the first aperture 73, the fourth coupling orifice 35, the third aperture 79, the fifth coupling orifice 55, and the second aperture 76, hence the at least one second steel ball 91 of the second safety bolt 90 moves across the second aperture 76 to engage the movable connection element 70. After disengaging the at least one second steel ball 91 from the second aperture 76, the second safety bolt 90 is removed from the first aperture 73 via the second aperture 76, the fifth coupling orifice 55, the third aperture 79, the fourth coupling orifice 35, and the first aperture 73.

The first tab 711 is welded on a peripheral side of a top of the third cover 77, and the second tab 741 is welded on a peripheral side of a bottom of the third cover 77, hence the first cover 71, the second cover 74 and the third cover 77 are opened or closed together.

The coupling disc 43 includes the respective one first coupling orifice 431 and the respective one first receiving orifice 432, the respective one arcuate clamp 45 is engaged with the Load flange nut rotor 40, and the first safety bolt 46 is received in the second through orifice 452 to open or close the Load flange nut rotor 40.

After removing the first safety bolt 46 and the second safety bolt 90, Open-closing flange nut structure for descending 20 is expanded to an angle to connect with descending thread rod 10, then the movable connection element 70 is pushed back to an original position to be closed, thereafter the second safety bolt 90 is fixed.

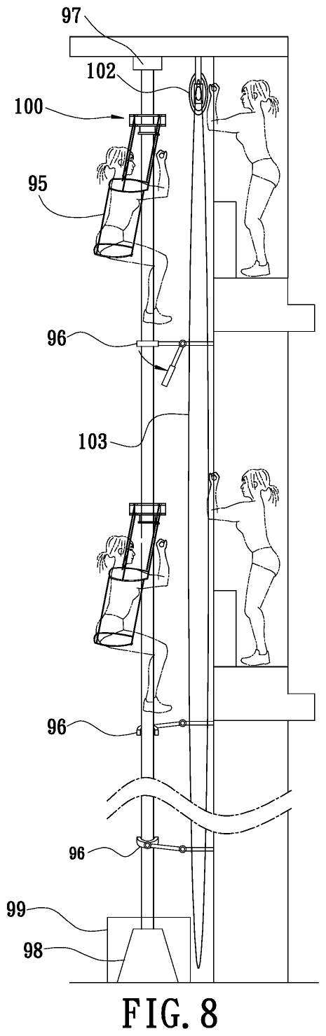

As shown in FIG. 8, the top and the bottom of descending thread rod 10 are fixed by using an upper holder 97 and a support base 98, and multiple U-shaped elasticity retainers 96 are configured to stabilize descending thread rod 10, wherein any two adjacent U-shaped elasticity retainers 96 are spaced at a predetermined distance. In a normal state, the multiple U-shaped elasticity retainers 96 clamp descending thread rod 10. When an escape personnel slides downward, the multiple U-shaped elasticity retainers 96 bent downward to remove from descending thread rod 10. After the escape personnel passes across the multiple U-shaped elasticity retainers 96, the multiple U-shaped elasticity retainers 96 move back to original positions to maintain descending thread rod 10 stably. In the normal state, the multiple U-shaped elasticity retainers 96 are perpendicular to descending thread rod 10 in multiple directions. For example, the multiple U-shaped elasticity retainers 96 are back to, rightward parallel to or leftward parallel to a wall of a building.

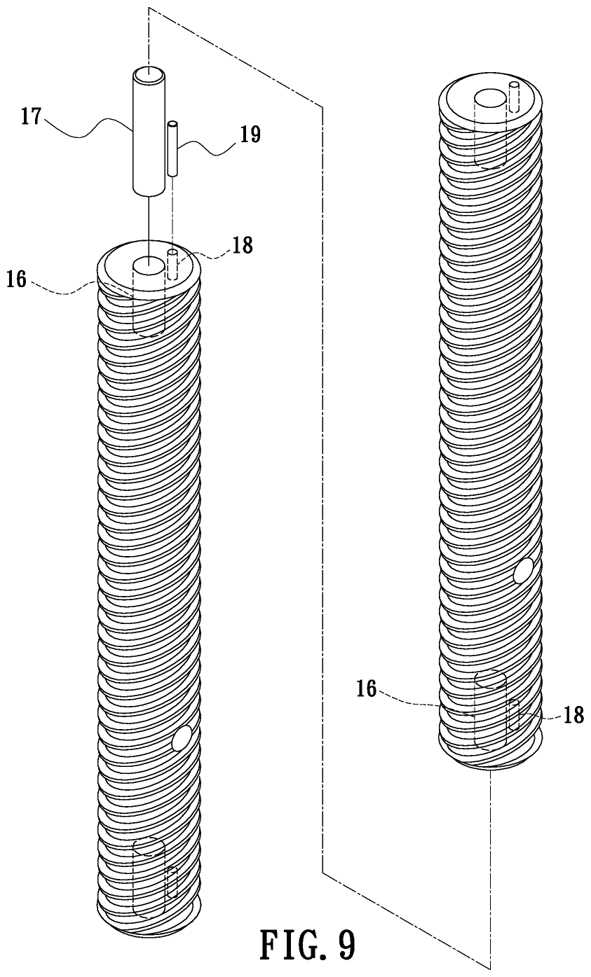

With reference to FIG. 9, two movable rods 10 are connected to form a combined movable rod 10 so as to be applicable for different floors of the building, wherein a respective one movable rod 10 includes two concentric holes 16 defined on two ends thereof so as to connect with a splicing column 17, thus connecting the two movable rods 10. The respective one movable rod 10 further includes two Positioning hole 18 defined on the two ends thereof and corresponding to the external threads 11, and a Positioning post 19 is configured to align and position the two movable rod 10 so that the Load flange nut rotor 40 moves on the two movable rods 19 smoothly.

The descended rescue device 100 hangs the escape personnel, descending thread rod 10 is inserted through the center of Open-closing flange nut structure for descending 20, and the descended rescue device 100 rotatably slides downward along the external threads 11, wherein when the descended rescue device 100 descends, the Load flange nut rotor 40 rotates so that the Multiple outer ring thrust rollers 301 and the Multiple inner ring thrust rollers 302 of the bottom cap 30 and the third threaded nuts 501 of the bottom cap 50 roll in the Outer ring guide trench 421, the Inner ring guide trench 422 and the middle ring guide trench 423, but the upper cover 30 and the bottom cap 50 are not actuated to revolve. A distance of the multiple columns 38 fixing the upper cover 30 and the bottom cap 50 enhances a deformation strength, the respective one arcuate clamp 45 limits an opening and a closing of the Load flange nut rotor 40, the first safety bolt 46 and the second safety bolt 90 control the opening and the closing of the Load flange nut rotor 40, the upper cover 30 and the bottom cap 50 so that the descended rescue device 100 hangs the escape personnel stably.

The flange nut stop pin 15 stops Open-closing flange nut structure for descending 20 to descend. After removing the flange nut stop pin 15, Open-closing flange nut structure for descending 20 rotatably slides downward to descend along the external threads 11 so that the rescue equipment 95 is hung by way of the upper cover 30, the bottom cap 50, the multiple first rings 36 and the multiple second rings 56. The rescue equipment 95 is escape suit.

The building has an exit, and a pulley 102 is arranged on the exit of the building, and a fireproof rope 103 is connected with the pulley 102. After using Open-closing flange nut structure for descending 20 and the rescue equipment 95, the rescue equipment 95 is manually delivered to other floor of the building via the pulley 102 and the fireproof rope 103.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A descended rescue device for a building comprising: a movable rod and a threaded structure;
wherein descending thread rod includes external threads formed on an outer wall thereof, and Open-closing flange nut structure for descending includes internal threads formed on a center thereof, descending thread rod further includes a flange nut stop pin, Open-closing flange nut structure for descending includes a upper cover, a Load flange nut rotor, a bottom cap, a fixed connection element, and a movable connection element, wherein the Load flange nut rotor is defined between the upper cover and the bottom cap, and the Load flange nut rotor includes the internal threads formed on the center thereof to mate with the external threads of descending thread rod, a loading disc fixed on a top thereof, a coupling disc mounted on a bottom of the Load flange nut rotor, and two arcuate clamps disposed on the coupling disc, wherein the loading disc has an Outer ring guide trench and an Inner ring guide trench formed on a top thereof, and the loading disc has a middle ring guide trench formed on a bottom thereof, wherein the Load flange nut rotor includes a first tangent slot formed beside the center thereof, the coupling disc has two first coupling orifices and two first receiving orifices located besides the first tangent slot;
wherein the upper cover includes a first passing orifice defined on a center thereof, the bottom cap includes a second passing orifice defined on a center thereof, wherein the upper cover includes a Cutting face of upper cover formed beside the center of the upper cover, two second coupling orifices defined besides the Cutting face of upper cover, a third coupling orifice and a fourth coupling orifice which are located beside the Cutting face of upper cover opposite to the two second coupling orifices, multiple first rings extending from an outer peripheral side of the upper cover, and multiple second receiving orifices configured to receive multiple columns, wherein the upper cover further includes Multiple outer ring thrust rollers and Multiple inner ring thrust rollers screwed on a bottom of the upper cover;
wherein the bottom cap includes a second passing orifice defined on a center thereof, a third tangent slot formed beside the center of the bottom cap, two third coupling orifices defined besides the third tangent slot, a fourth coupling orifice and a fifth coupling orifice which are located beside the third tangent slot opposite to the two third coupling orifices, multiple second rings extending from an outer peripheral side of the bottom cap, and multiple third receiving orifices configured to receive multiple columns, wherein the bottom cap further includes multiple third threaded nuts and multiple fourth threaded nuts screwed on a top of the bottom cap;
wherein the fixed connection element includes a first lid, a second lid, a third lid, and two joining stems, wherein the first lid has a first hole, the second lid has a second hole, and the third lid has a third hole, wherein the first lid is disposed on the top of the first cap, the second lid is mounted on the bottom of the bottom cap, and the third lid is defined between the upper cover and the bottom cap, a respective one joining stem is inserted through the first hole, a respective one second coupling orifice, the third hole and a respective one third coupling orifice to connect with the second hole;
wherein the movable connection element includes a first cover, a second cover, a third cover, a locating shaft, and a second safety bolt, wherein the second safety bolt has at least one second steel ball received on a bottom thereof, and the first cover has a first tab, a first opening, and a first aperture, wherein the second cover has a second tab, a second opening, and a second aperture, wherein the third cover has a third opening and a third aperture, wherein the first cover is disposed on the top of the first cap, the second cover is fixed on the bottom of the bottom cap, and the third cover is defined between the first cap and the bottom cap;
wherein Open-closing flange nut structure for descending is screwed with descending thread rod at any desired height so as to slide downward to descend along descending thread rod, and rescue equipment is hung by way of the upper cover, the bottom cap, the multiple first rings and the multiple second rings, wherein the rescue equipment is escape suit.

2. The descended rescue device as claimed in claim 1, wherein an end of the movable connection element is fixed by inserting the locating shaft through the first opening, the third coupling orifice of the upper cover, the third opening, the fourth coupling orifice of the bottom cap, and the second opening; the other end of the movable connection element is fixed by inserting the second safety bolt through the first aperture, the fourth coupling orifice, the third aperture, the fifth coupling orifice, and the second aperture, hence the at least one second steel ball of the second safety bolt moves across the second aperture to engage the movable connection element; after disengaging the at least one second steel ball from the second aperture, the second safety bolt is removed from the first aperture via the second aperture, the fifth coupling orifice, the third aperture, the fourth coupling orifice, and the first aperture; the first tab is welded on a peripheral side of a top of the third cover, and the second tab is welded on a peripheral side of a bottom of the third cover, hence the first cover, the second cover and the third cover are opened or closed together.

3. The descended rescue device as claimed in claim 1, wherein the flange nut stop pin is configured to stop Open-closing flange nut structure for descending to descend.

4. The descended rescue device as claimed in claim 1, wherein the coupling disc includes a respective one first coupling orifice and a respective one first receiving orifice, a respective one arcuate clamp is engaged with the Load flange nut rotor, and the first safety bolt is received in the second through orifice to open or close the Load flange nut rotor.

5. The descended rescue device as claimed in claim 1, wherein when the descended rescue device descends, the Load flange nut rotor rotates so that the Multiple outer ring thrust rollers and the Multiple inner ring thrust rollers of the bottom cap and the third threaded nuts of the bottom cap roll in the outer groove, the Inner ring guide trench and the middle ring guide trench, but the upper cover and the bottom cap are not actuated to revolve, thus hanging the escape personnel by using the descended rescue device.

6. The descended rescue device as claimed in claim 1, wherein a pulley is arranged on an exit of a building, and a fireproof rope is connected with the pulley, such that after using Open-closing flange nut structure for descending and rescue equipment, the rescue equipment is manually delivered to other floors of the building via the pulley and the fireproof rope.

7. The descended rescue device as claimed in claim 1, wherein two movable rods are connected to form a combined movable rod so as to be applicable for different floors of the building, wherein the respective one movable rod includes two concentric holes defined on two ends thereof so as to connect with a splicing column, thus connecting the two movable rods; wherein the respective one movable rod further includes two Positioning hole defined on the two ends thereof and corresponding to the external threads, and a Positioning post is configured to align with and position the two movable rod so that the Load flange nut rotor moves on the two movable rods smoothly.

8. The descended rescue device as claimed in claim 1, wherein the top and the bottom of descending thread rod are fixed by using an upper holder and a support base, and multiple U-shaped elasticity retainers are configured to stabilize descending thread rod, wherein any two adjacent U-shaped elasticity retainers are spaced at a predetermined distance; in a normal state, the multiple U-shaped elasticity retainers clamp descending thread rod; when an escape personnel slides downward, the multiple U-shaped elasticity retainers bent downward to remove from descending thread rod; after the escape personnel passes across the multiple U-shaped elasticity retainers, the multiple U-shaped elasticity retainers move back to original positions to maintain descending thread rod stably; in the normal state, the multiple U-shaped elasticity retainers are perpendicular to descending thread rod in multiple directions.
